(19) United States
(12) Patent Application Publication
(10) Pub. No.: US 2007/0088644 A1
(43) Pub. Date: Apr. 19, 2007

(54) Financial Instrument

(76) Inventor: Dwight Carlson, Ann Arbor, MI (US)

Correspondence Address: SCHOX PLC, 209 N. MAIN STREET #200, ANN ARBOR, MI, 48104, US

(21) Appl. No.: 11/549,771

(22) Filed: Oct. 16, 2006

Related U.S. Application Data
(60) Provisional application No. 60/727,756, filed on Oct. 18, 2005.

(51) Int. Cl. G06Q 40/00

(52) U.S. Cl. 705/35

(57) ABSTRACT

In the preferred embodiment, the invention includes a combination of three financial agreements: a first financial agreement entered between a first entity (such as an angel investor) and a second entity (such as a financial services company), a second financial agreement entered between a third entity (such as a startup company) and the second entity, wherein the first financial agreement is collateral for the second financial agreement, and a third financial agreement entered between the first entity and the third entity. The first financial agreement preferably includes a money deposit from the first entity to the financial services company for a defined term. The second financial agreement preferably includes a loan from the financial services company to the third entity. The third financial agreement preferably includes a security (such as an equity or debt security) from the third entity to the first entity.

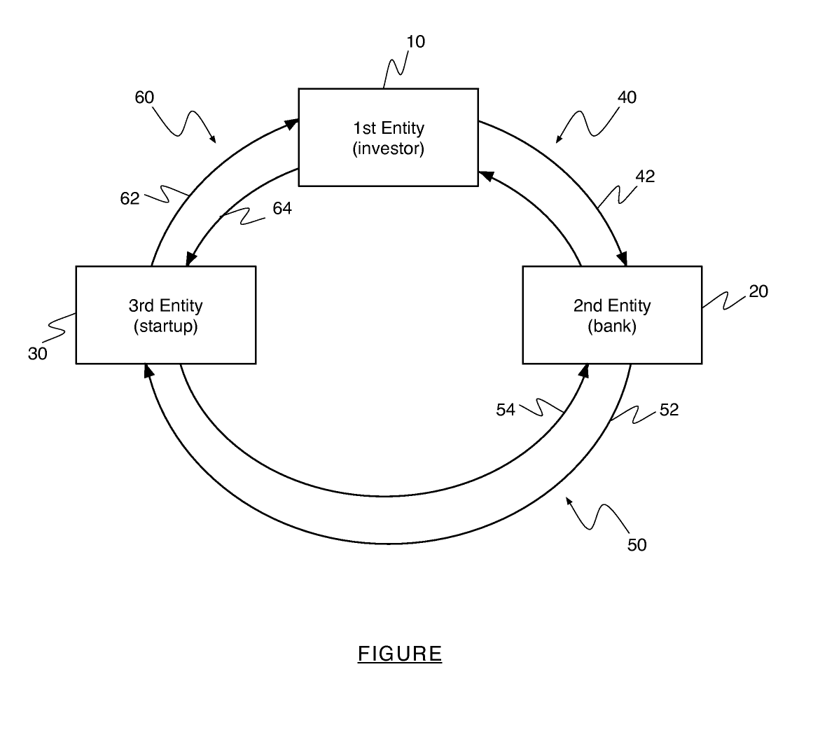

### CROSS-REFERENCE TO RELATED APPLICATIONS

This application claims the benefit of U.S. Provisional Application No. 60/727,756 filed 18 Oct. 2005 and entitled “Derivative Financial Instrument”, which is incorporated in its entirety by this reference.

### TECHNICAL FIELD

This invention relates generally to the financial services field, and more specifically to a new and useful combination of financial agreements in the financial services field.

### BACKGROUND

Affectionately known as the “Valley of Death”, a startup company typically experiences a challenging time period after the infusion of “friends and family” funding and before a sustainable break-even point. While it is usually difficult to raise more than $100,000 to $200,000 from friends and family, most venture capital funds will not consider investments under $1,000,000 to $2,000,000. While a startup company may have plans to expand, it is typically limited by the lack of working capital. Loans for startup companies, which typically have short credit records, have relatively high interest rates, which create great drag on expansion plans of startup companies. Further, startup companies have a difficult time selling shares or warrants if they are not listed on a stock exchange.

Thus, there is a need in the financial services field to create a new and useful financial instrument that increases the working capital of a startup company. This invention provides such new and useful financial instrument.

### BRIEF DESCRIPTION OF THE FIGURE

The FIGURE is a flowchart of the combination of financial agreements according to the preferred embodiment of the invention.

### DESCRIPTION OF THE PREFERRED EMBODIMENT

The following description of the preferred embodiment of the invention is not intended to limit the invention to this preferred embodiment, but rather to enable any person skilled in the art of financial services to make and use this invention.

In the preferred embodiment, as shown in the FIGURE, the invention includes a combination of three financial agreements: a first financial agreement 40 entered between a first entity 10 and a second entity 20, a second financial agreement 50 entered between a third entity 30 and the second entity 20, wherein the first financial agreement 40 is collateral for the second financial agreement 50, and a third financial agreement 60 entered between the first entity 10 and the third entity 30. The invention has been specifically designed for at least one angel investor as the first entity 10, a financial services company such as a bank as the second entity 20, and at least one startup company as the third entity 30. The angel investor and the startup company are conventional parties to an early stage investment opportunity. The bank, however, is not. The bank serves as the focal point for the transaction of the financial agreements. People are generally comfortable with giving confidential information to banks, which are regulated by the Federal Banking Laws, and people generally view banks as conservative, honest and trustworthy, providing a level of comfort with the transactions. The invention may, however, be suitable for other situations. For example, any suitable entity may be the first entity 10, any suitable lender may be the second entity 20, and any suitable borrower may be the third entity 30.

The first financial agreement 40 of the preferred embodiment is entered between the first entity 10 and the second entity 20. The first financial agreement 40 functions to act as collateral 64 for the second financial agreement 50, and may also function as a relatively low-risk investment and relatively secure revenue stream for the first entity 10. The first financial agreement 40 preferably includes a money deposit 42 from the first entity 10 to the second entity 20. The money deposit 42 is preferably a time deposit for an appropriate fixed term (e.g., three months, one year, or five years) with an appropriate fixed or variable interest rate, and preferably includes a corresponding Certificate of Deposit 44 from the second entity to the first entity. The term and interest rate may be varied to match the investment risk. The money deposit 42 may alternatively be a savings deposit or a transaction deposit with suitable restrictions or limitations. The first financial agreement 40 alternatively includes a loan, a bond, a note, a dividend-bearing stock or other security, or any other suitable financial instrument that functions as collateral 64 for the second financial agreement 50.

The second financial agreement 50 of the preferred embodiment is entered between the second entity 20 and the third entity 30. The second financial agreement 50 functions to increase the working capital of the third entity 30. The second financial agreement 50 preferably includes a debt 52 between the second entity 20 and the third entity 30. The debt 52 is preferably a loan from the second entity 20 to the third entity 30, and preferably includes a corresponding promissory note 54 from the third entity to the second entity, but may alternatively include bonds or any other suitable financial instrument that increases the working capital of the third entity 30. The amortization of the loan can be annual or there may be no amortization at all during the term of the loan. The second financial agreement 50 is preferably secured with the first financial agreement 40. In this manner, the second entity 20 is secured against the default risk of the third entity 30. If the third entity defaults on the loan, the second entity takes the CD and the first entity loses the investment in the CD. The first entity, however, preferably becomes a creditor during the liquidation of the third entity and, as a creditor, is in a better position than a stockholder.

The third financial agreement 60 of the preferred embodiment is entered between the first entity 10 and the third entity 30, and may also function as a relatively high-risk investment and relatively unpredictable revenue stream for the first entity 10. The third financial agreement 60 functions to compensate the first entity 10 for providing the collateral of the second financial agreement 50. The third financial agreement 60 is preferably a security 62 (such as an equity or debt security) from the third entity 30 to the first entity 10. In a first variation, the security 62 includes a debt security in the form a promissory note (with or without an interest payment). In a second variation, the security 62 includes an equity security in the form of at least one option or warrant for at least one share of the third entity 30. In a third variation, the security 62 includes both debt security in the form a promissory note and an equity security in the form of at least one option or warrant for at least one share of the third entity 30. The term of the warrant and the coverage of the warrant (i.e., the number of shares obtained on conversion of the loan) can be varied to match the risk inherent in the investment. Finally, in alternative variations, the third financial agreement 60 may include any suitable financial instrument that compensates the first entity 10 for providing the collateral 64 of the second financial agreement 50.

As a person skilled in the art of financial services will recognize from the previous detailed description and from the figures and claims, modifications and changes can be made to the preferred embodiments of the invention without departing from the scope of this invention defined in the following claims.

I claim:

1. A combination of financial agreements, comprising:
a first financial agreement entered between a first entity and a second entity;
a second financial agreement entered between a third entity and the second entity, wherein the first financial agreement is collateral for the second financial agreement; and
a third financial agreement entered between the first entity and the third entity.

2. The combination of claim 1, wherein the second entity is a financial services company.

3. The combination of claim 2, wherein the first financial agreement includes a money deposit from the first entity to the financial services company for a defined term.

4. The combination of claim 3, wherein the second financial agreement includes a loan from the financial services company to the third entity.

5. The combination of claim 4, wherein the third financial agreement includes a security from the third entity to the first entity.

6. The combination of claim 5, wherein the security includes debt security in the form a promissory note.

7. The combination of claim 5, wherein the security includes an equity security in the form of at least one warrant for at least one share of the third entity.

8. The combination of claim 5, wherein the security includes both debt security in the form a promissory note and an equity security in the form of at least one warrant for at least one share of the third entity.

9. A method of providing financial services, comprising the following steps:
entering a first financial agreement with a first entity;
entering a second financial agreement with a third entity; and
accepting the first financial agreement as collateral for the second financial agreement.

10. The method of claim 9, wherein the step of entering a first financial agreement includes accepting a money deposit from the first entity for a defined term.

11. The method of claim 10, wherein the step of entering a second financial agreement includes providing a loan to the third entity.

12. A method of investing, comprising the following steps:
entering a first financial agreement with a second entity;
providing the first financial agreement as collateral for a second financial agreement between a third entity and the second entity; and
entering a third financial agreement with the third entity.

13. The method of claim 12, wherein the step of entering a first financial agreement includes entering a first financial agreement with a financial services company.

14. The combination of claim 13, wherein the step of entering a first financial agreement includes depositing money with the financial services company for a defined term.

15. The combination of claim 14, wherein the step of providing the first financial agreement as collateral for a second financial agreement includes providing the first financial agreement as collateral for a loan from the financial services company to the third entity.

16. The combination of claim 15, wherein the step of entering a third financial agreement with the third entity includes accepting a security from the third entity.
